(19) United States
(12) Patent Application Publication
(10) Pub. No.: US 2019/0319508 A1
(43) Pub. Date: Oct. 17, 2019

(54) Stator and Electrical Connection Cap thereof

(71) Applicant: Victory Industrial Corporattion, New Taipei City (TW)

(72) Inventors: Hung-Chih CHANG, New Taipei City (TW); Chang-Si Yang, New Taipei City (TW)

(21) Appl. No.: 16/372,135

(22) Filed: Apr. 1, 2019

Related U.S. Application Data
(60) Provisional application No. 62/657,403, filed on Apr. 13, 2018.
(60) Provisional application No. 62/657,425, filed on Apr. 13, 2018.
(60) Provisional application No. 62/657,440, filed on Apr. 13, 2018.
(60) Provisional application No. 62/657,453, filed on Apr. 13, 2018.
(60) Provisional application No. 62/790,868, filed on Jan. 10, 2019.

(51) Int. Cl. H02K 3/50

(52) U.S. Cl. CPC H02K 3/50

(57) ABSTRACT

The present disclosure provides an electrical connection cap of a stator. The electrical connection cap includes a housing and at least one connection sheet. The housing has a first opening and a second opening. The at least one connection sheet is embedded within the housing and has a first receiving part positioned in the first opening, and a second receiving part positioned in the second opening.

### CROSS REFERENCE TO RELATED APPLICATIONS

This applications claims the benefit of priority from the following US applications, each of which is herein incorporated by reference in their entirety for all purposes:

U.S. provisional patent application 62/657,403 filed Apr. 13, 2018;

U.S. provisional patent application 62/657,425 filed Apr. 13, 2018;

U.S. provisional patent application 62/657,440 filed Apr. 13, 2018;

U.S. provisional patent application 62/657,453 filed Apr. 13, 2018; and

U.S. provisional patent application 62/790,868 filed Jan. 10, 2019.

### TECHNICAL FIELD

The present disclosure generally relates to a stator, and more specifically to a stator and an electrical connection cap thereof.

### BACKGROUND

An existing alternator is typically used for converting mechanical energy into alternating-current electrical energy. When a vehicle is equipped with an alternator, an induced current is generated by the combined operation of a stator and a rotor driven by an engine. Specifically, the rotor includes a coil of wires wrapped around a metal core. Currents through the wire coil produce a magnetic field around the metal core. The strength of the magnetic field is determined by the field strength of the field current. The field current may be a direct current supplied by brushes and slip rings. When an engine operates, the rotor is accordingly driven to rotate via an alternator pulley coupled to the engine.

A stator may have several sets of windings wound around a stator core and surrounding the rotor. The stator is fixed to a housing of the alternator, and does not turn. As the rotor turns within the stator windings, the magnetic field of the rotor sweeps through the stator windings, producing an electromotive force that generates an electrical current in the stator windings. This current can charge a battery for supplying power to other electrical parts in the vehicle. Hence, the mechanical energy generated from an engine can be converted into electrical energy by the use of the alternating-current alternator.

In an existing stator, for the development of a magnetic field in a three-phase stator, it is imperative that the current in these three-phase windings must be 120 degrees placed with each other. In order to achieve this, either star or delta configurations can be applied. Thus, the windings may be coupled to a rectifier for the purpose of converting an alternate current into a direct current.

The windings are, however, made of several wires that are connected in cascade or in parallel in order to form the three phases. Two wires can be manually coupled together by a twisting or a soldering process. If there are many wires that need to be coupled together, it would be cumbersome and time-consuming to arrange those wires. Besides, two wires may be mistakenly coupled to each other during this intricate coupling process, causing an undesirable malfunction.

What is needed, therefore, is a stator and an electrical connection cap thereof, in which wires are easily arranged in an orderly manner.

### SUMMARY OF INVENTION

In accordance with an aspect of the present disclosure, an electrical connection cap of a stator is provided. The electrical connection cap includes a housing and at least one connection sheet. The housing has a first opening and a second opening. The at least one connection sheet is embedded within the housing. The at least one connection sheet has a first receiving part positioned in the first opening, and a second receiving part positioned in the second opening.

In accordance with another aspect of the present disclosure, a stator is provided including a stator core, a stator winding and an electrical connection cap. The stator core has multiple teeth that are circumferentially spaced apart and radially extending. The teeth define multiple slots, each formed between two of the teeth adjacent to each other. The stator winding is wound around the teeth and includes a first wire, a second wire and a third wire, each of which extends out of the slots. The electrical connection cap is positioned on an axial side of the stator winding. The electrical connection cap includes a housing, at least one connection sheet and a cable. The housing has a first opening, a second opening and an orifice. The at least one connection sheet is embedded within the housing and has a first receiving part positioned in and exposed from the first opening, and a second receiving part positioned in and exposed from the second opening. The first wire is coupled to the first receiving part in the first opening. The second wire is coupled to the second receiving part in the second opening. The cable has a connecting section, a positioning section and an extending section that are connected in series. The connecting section is coupled to the third wire in the orifice. The positioning section is positioned on top of the housing. The extending section extends towards a direction farther away from the stator core.

### BRIEF DESCRIPTION OF THE DRAWINGS

The invention, as well as a preferred mode of use, further objectives, and advantages thereof, will be best understood by referring to the following detailed description of illustrative embodiments in conjunction with the accompanying drawings, wherein:

FIG. 1 is a perspective view of a stator according to an embodiment of the disclosure;

FIG. 2 is an exploded view of the stator in FIG. 1;

FIG. 3 is a regionally enlarged view of the stator in FIG. 1;

FIG. 4 is a perspective view of the stator in FIG. 1 in which the housings and cables are omitted;

FIG. 5 is an exploded view of the connections and the blocks of the first and the second electrical connection caps in FIG. 1;

FIG. 6 is a perspective view of a stator according to another embodiment of the disclosure; and

FIG. 7 is a regionally enlarged top view of the stator in FIG. 6.

### DETAILED DESCRIPTION

The characteristics, subject matter, advantages, and effects of the present disclosure are detailed hereinafter by reference to embodiments of the present disclosure and the accompanying drawings. It is understood that the drawings referred to in the following description are intended only for purposes of illustration, and do not necessarily show the actual proportion and precise arrangement of the embodiments. Therefore, the proportion and arrangement shown in the drawings should not be construed as limiting or restricting the scope of the present invention.

The terminology used in the description of the present disclosure herein is for the purpose of describing particular embodiments only, and is not intended to be construed as a limitation of the invention. As used in the description of the invention and the appended claims, the singular articles of “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

The present disclosure provides a wound stator that is installed with a rotor, a housing, and several parts, such as rectifier, so as to form an alternator, i.e., alternating-current generator. A vehicle may be equipped with the alternator, for example, a car, forklift, hoist, lawn mower, and the like, with a view to providing electrical power for several electronic parts installed in a vehicle, such as lamps, infrared sensor, air conditioner, radio, rear-view camera, and the like.

The stator has several sets of wire coils wound around a stator core that surrounds the rotor. The stator core is cylindrical in shape and has numerous teeth formed on the inner circumference surface of its core body. In particular, the teeth extend from the core body towards the axis of the stator. Numerous slots are defined between every two adjacent teeth, respectively. Wires are inserted into the slots and wound around the teeth to form several coils.

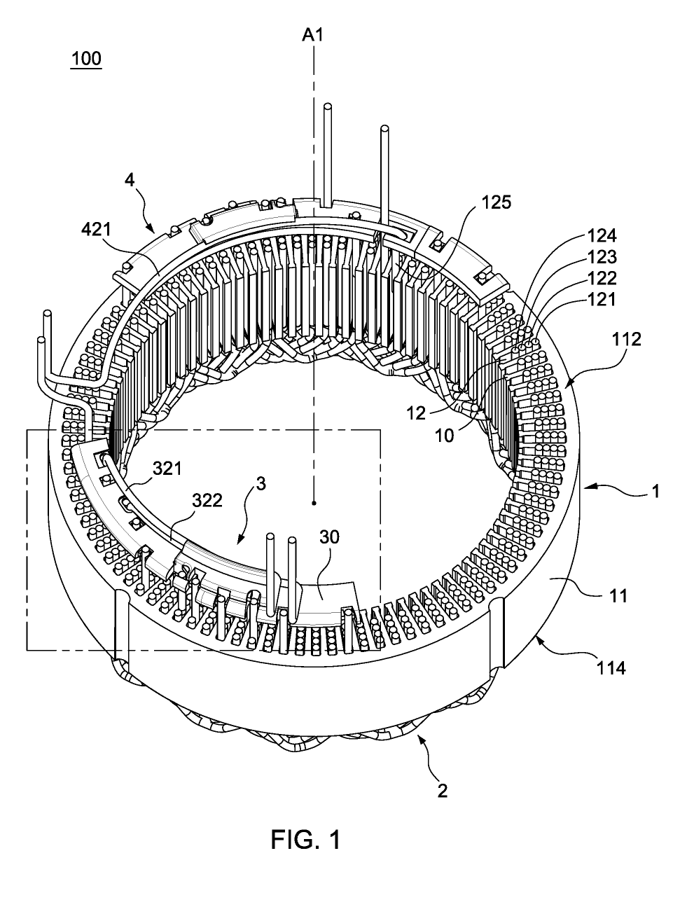

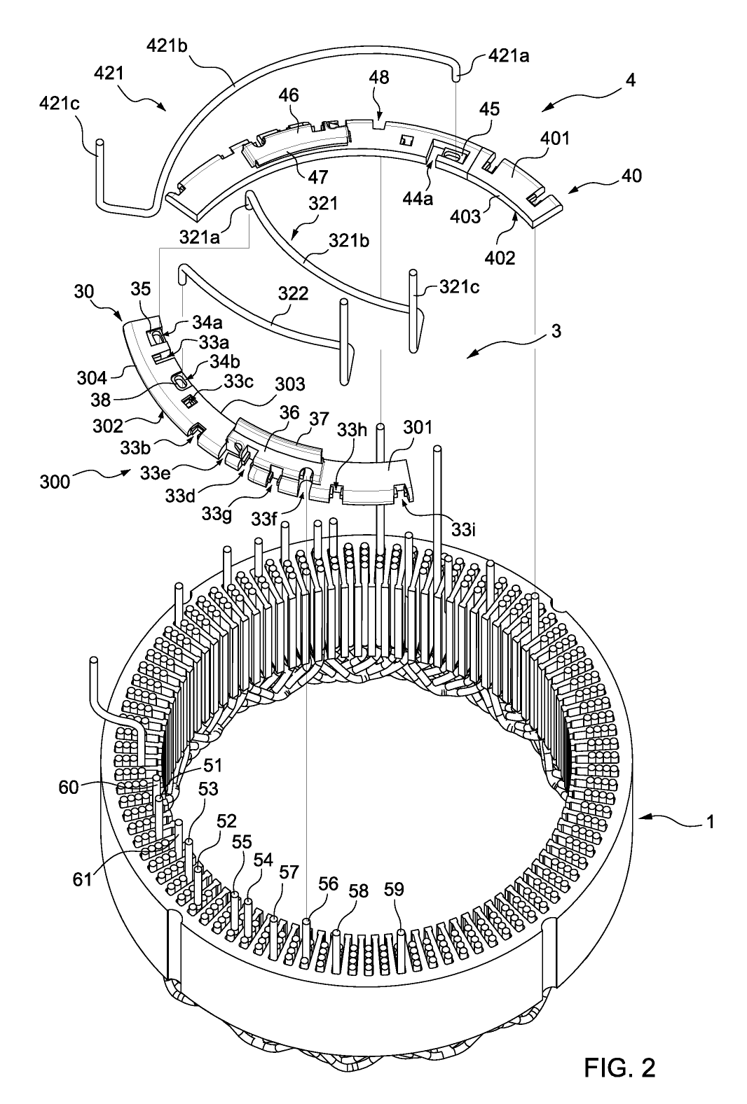

FIG. 1 is a perspective view of a stator 100 according to an embodiment of the disclosure. FIG. 2 is an exploded view of the stator 100 in FIG. 1. The following describes a stator in which wires may be arranged easily and in an orderly manner. The stator 100 includes a stator core 1, several stator windings 2 and two electrical connection caps 3, 4.

In some embodiments of the disclosure, the stator core 1 has a core body 11 and multiple teeth 10. The core body 11 is cylindrical in shape. The core body 11 may be made of metal sheets that are laminated together to form a multi-layer structure. The core body 11 has two opposing axial sides, which includes an upper axial side 112 and a lower axial side 114, and defines a space therein for accommodating a rotor. The teeth 10 are circumferentially spaced apart and radially extend towards the axis of the stator 100 from the core body 11. The teeth 10 define multiple slots 12 and each is formed between two of the teeth 10 adjacent to each other. In other embodiments, the teeth 10 are formed on the outer circumferential surface of the core body 11 such that the teeth 10 radially extend out of the core body 11.

In some embodiments of the disclosure, the stator winding 2 is wound around the teeth 10 of the stator core 1. Each stator winding 2 includes several coils made of multiple wires connected together. In this embodiment, some portions of the wires are located in the slots 12 defined between the teeth 10, and four or five wires are radially arranged in a single slot 12 to have first row 121 to fourth row 124 or fifth row 125 in the slots. The first row 121 is the closest row to the outer side of the stator core 1 among all rows 121-125 of wires. The fourth row 124 or fifth row 125 is the closest to the inner side of the stator core 1. Moreover, the coils are connected together in series or parallel to form three-phase windings that may be coupled to a rectifier configured to convert an alternating current into a direct current. For example, the windings are connected by means of delta or star connections.

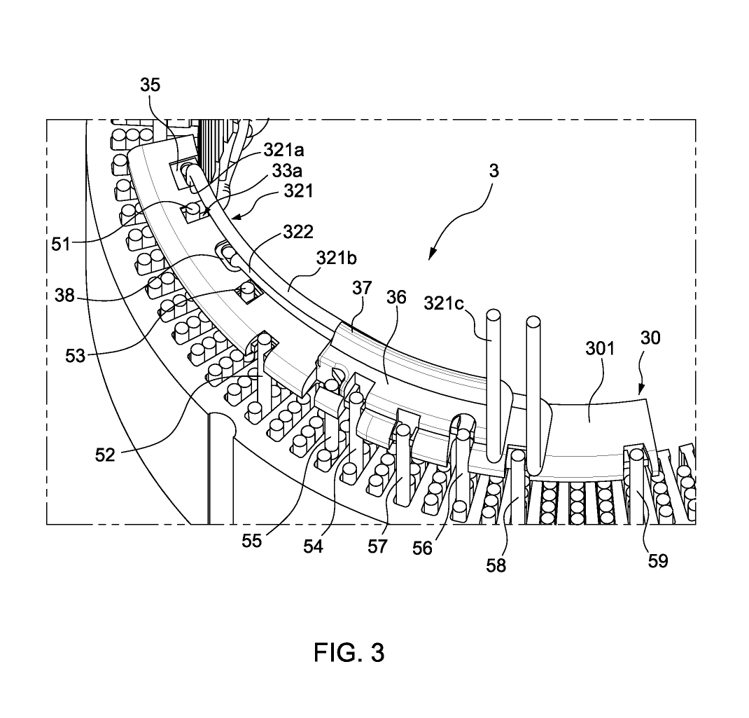

FIG. 3 is a regionally enlarged view of the stator 100 in FIG. 1. With reference to FIGS. 1-3, in some embodiments of the disclosure, the electrical connection caps 3, 4 surround about the axis A1 of the stator 100 in part, such that the electrical connection caps 3, 4 are arc-shaped. In addition, the electrical connection caps 3, 4 are positioned at the upper axial side 112 of the stator core 1 such that each of the electrical connection caps 3, 4 covers a different portion of the stator windings 2. In other embodiments, the electrical connection cap 3 is located at the upper 112 axial side, and the electrical connection cap 4 is positioned at the lower axial side 114. It is understood that the wave-shaped portions of the stator winding 2 that are exposed outside of the stator core 1 are omitted in FIGS. 1-4 in order to clearly illustrate other components of the stator 100.

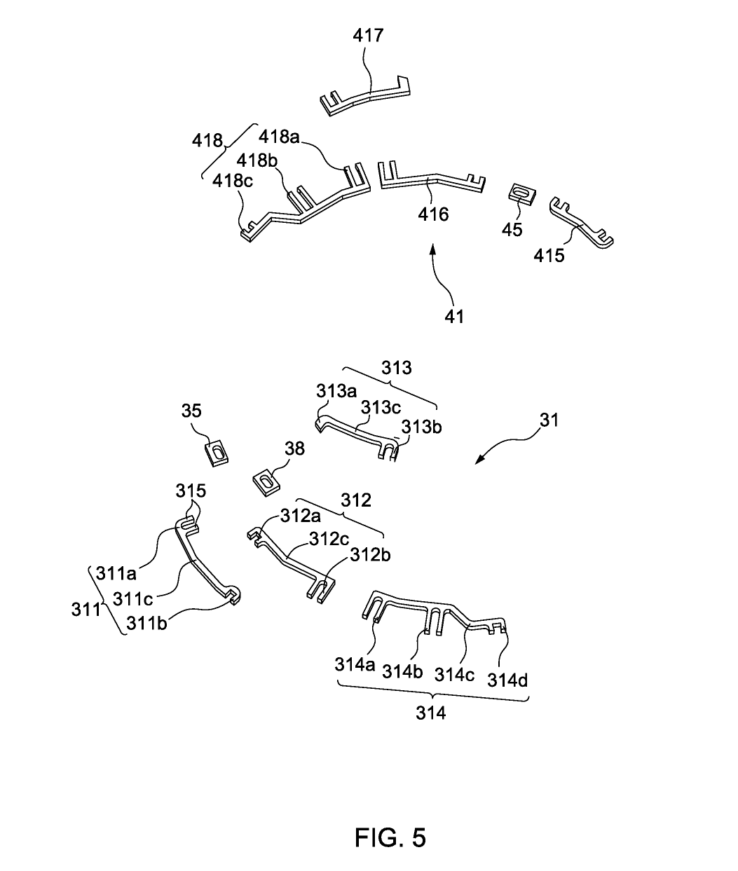

In one embodiment of the disclosure as shown in FIGS. 2 and 5, each of the electrical connection caps 3, 4 includes a housing 30, 40, several connection sheets 31, 41 and at least one cable 321, 322, 421. In terms of the electrical connection cap 3, the housing 30 may be made from a non-conducting material, e.g., plastic. The plastic may be fiberglass. The housing 30 includes a body 300 having a first surface 301, a second surface 302, an inner surface 303, and an outer surface 304. The first surface 301, which may be a top surface, opposes the second surface 302 and faces away from the stator core 1; whereas the second surface 302, which may be a bottom surface, faces toward the stator core 1. The inner surface 303 opposes the outer surface 304 and faces an axis A1 of the stator 100 such that the inner surface 303 is located at the inner side of the electrical connection cap 3; whereas the outer surface 304 faces away from the axis A1 of the stator 100 such that the outer surface 303 is located at the outward side of the electrical connection cap 3. In this embodiment, the electrical connection cap 3 is arch-shaped, and the inner surface 303 and the outer surface 304 are curved. Besides, a fillet edge is formed between the outer surface 304 and the first surface 301 for reducing the volume and weight of the electrical connection caps 3, as well as avoiding any interference with other components. In addition, the housing 30 has multiple openings, i.e., the first to ninth openings 33a-33i, and multiple orifices, i.e., the first and second orifices 34a-34b. The openings 33a-33i and orifices 34a-34b are defined at different locations of the housing 30. It should be apparent that the numbers and configurations of the openings and orifices disclosed in this embodiment are not limited to those shown in the disclosure, and a person skilled in the art can modify the numbers and the configurations of the openings and the orifices shown in the disclosure without departing from the spirit of this disclosure.

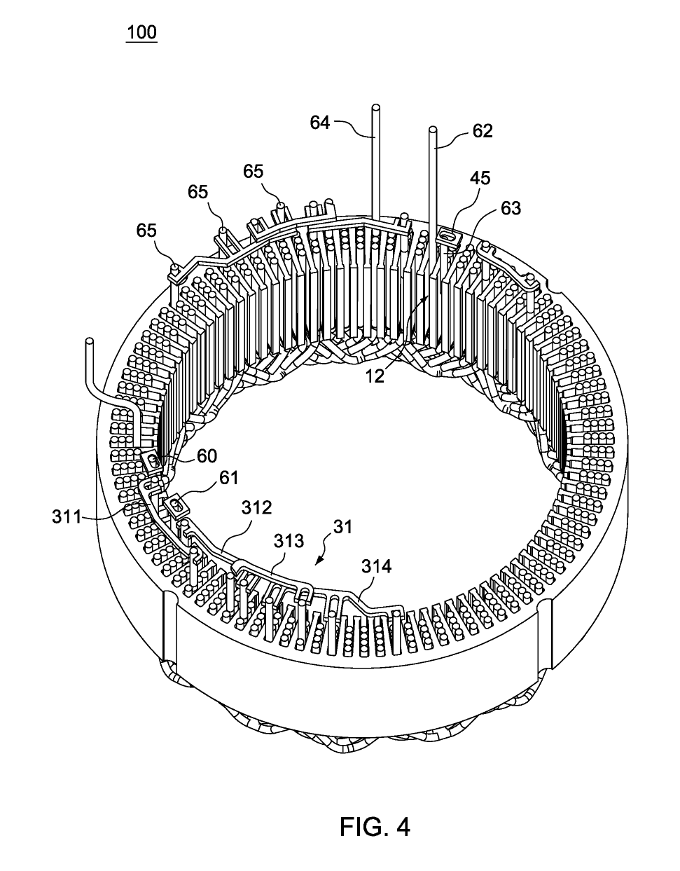

FIG. 4 is a perspective view of the stator in FIG. 1 in which housings 30, 40 and the cables are omitted. FIG. 5 is an exploded view of connection sheets 31, 41 and blocks 35, 38, 45 of the first and the second electrical connection caps 3, 4 in FIG. 1. As shown in FIGS. 1-5, in some embodiments of the disclosure, the connection sheets 31 are embedded within the housing 30. For example, when the housing 30 is manufactured by injection molding, the connection sheets may be placed onto a mold before the housing is formed within the mold, in order that the connection sheets can be embedded in the housing. In some embodiments of the disclosure, the connection sheets 31 include a first connection sheet 311, a second connection sheet 312, a third connection sheet 313, and a fourth connection sheet 314, each of which is not in direct contact with each other. In other words, every two of the connection sheets 31 may be separated from each other by a portion of the housing 30 in order that every two of the connection sheets 31 are not directly in contact with each other.

In some embodiments of the disclosure, the first connection sheet 311 has a first receiving part 311a, a second receiving part 311b, and an extending part 311c. The extending part 311 connects the first receiving part 311a and the second receiving part 311b. The first receiving part 311a is positioned in and exposed from the first opening 33a that may be formed on the inner surface 303 and that may extend through the top surface 301 and bottom surface 302, such that the first opening 33a is formed in the inner edge of the housing 30 facing the axis A1. The second receiving part 311b is positioned in and exposed from a second opening 33b that may be formed on the outer surface 304 and extend through the top surface 301 and bottom surface 302, such that the second opening 33b is formed in the outer edge of the housing 30 facing away from the axis A1. As illustrated in FIGS. 2, 3 and 5, an end of the first wire 51 in the fourth row 124 of the stator windings 2 is coupled to the first receiving part 311a in the first opening 33a. An end of the second wire 52 in the second row 122 of the stator windings 2 is coupled to the second receiving part 311b in the second opening 33b. In this embodiment, the first wire 51 and the second wire 52 vertically jut out of the slots 12 to be coupled to the respective first and second receiving parts 311a, 311b. The end of the first wire 51 may be abutting the first receiving part 311a so that they are in direct contact. Hence, by placing the electrical connection caps 3 on the stator windings 2 to couple the first wire 51 with the second wire 52 via the first connection sheet 311 inside the housing 30, it is unnecessary for a user to grasp and pull a wire to another wire to couple them together, given that once the electrical connection cap 3 is placed on a certain position of the stator windings 2, all receiving parts are able to be directly coupled with corresponding wires, respectively, the electrical couplings between two wires are attained. In this disclosure, the term “vertically” refers to a vertical direction that is substantially parallel to the axis A1 of the stator 100.

In one embodiment of the disclosure as shown in FIG. 5, the first receiving part 311a includes two protrusions 315 jutting out from the extending part 311c and spaced apart from each other by a distance so that the first receiving part 311a is C-shaped. The first wire 51 can be inserted into the space defined by the two protrusions 315 and a part of the extended part 311c to engage with the first connection sheet 311, which increases the contact area and thereby enhances the electrical conduction between them. In addition, the second receiving part 311b is a C-shaped structure having a space in which the second wire 52 can be inserted.

In other embodiments, the first wire 51 may be bent or twisted to be in direct contact with the first receiving part 311a in order to increase the contact area between them. Alternatively, an end of the first wire 51 may be soldered or welded to the receiving part 311a. In other embodiments, the first opening 33a may be formed only in the second surface 302 and is not exposed from the first surface 301 and inner surface 303, so that the first wire 51 can be inserted into the first opening 33a only through the second surface 302. Similarly, the second opening 33b may be formed only on the second surface 302 and is not exposed from the first surface 301 and the outer surface 304.

In some embodiments of the disclosure, the second connection sheet 312 has a third receiving part 312a, a fourth receiving part 312b and an extending part 312c that connects the third receiving part 312a and the fourth receiving part 312b. The third opening 33c extends through the first surface 301 and the second surface 302, but not the inner surface 303 and the outer surface 304. The fourth opening 33d is formed on the outer surface 304 and extends from the first surface 301 to the second surface 302. In addition, along the lengthwise direction of the electrical connection cap 3, the third opening 33c is positioned between the first opening 33a and the second opening 33b, and the second opening 33b is positioned between the third opening 33c and the fourth opening 33d. The third receiving part 312a is positioned in the third opening 33c, and the fourth receiving part 312b is positioned in the fourth opening 33d. By placing a third wire 53 of the fourth row 124 into the third opening 33c to be coupled with the third receiving part 312a and placing the fourth wire 54 of the second row 122 into the fourth opening 33d to be coupled with the fourth receiving part 312b, the electrical coupling between the third and fourth wires 53 and 54 are attained.

The relative locations between the first and the second connection sheets 311, 312 may be adjusted according to actual requirements. For example, in one embodiment as shown in FIGS. 2 and 4-5, the extending part 311c of the first connection sheet 311 is received within the electrical connection cap 3 and positioned radially outward of the extending part 312c of the second connection sheet 312. In one embodiment, the third and the fourth openings 33c-33d are located between the first and the second opening 33a, 33b such that the third and the fourth receiving parts 312a, 312b are located between the first and the second receiving parts 311a, 311b.

In some embodiments of the disclosure, the third connection sheet 313 has a fifth receiving part 313a, a sixth receiving part 313b and an extending part 313c that connects the fifth receiving part 313a and the sixth receiving part 313b. The fifth and sixth openings 33e-f are both formed on the outer surface 304 and extend through the first surface 301 and the second surface 302. Along the lengthwise direction of the electrical connection caps 3, the third opening 33c is positioned between the first opening 33a and the second opening 33b, and the fourth opening 33d is positioned between the fifth opening 33e and the sixth opening 33f. The fifth receiving part 313a is positioned in the fifth opening 33e, and the sixth receiving part 313b is positioned in the sixth opening 33f. By placing a fifth wire 55 of the second row 122 into the fifth opening 33e to be coupled with the fifth receiving part 313a, and placing the sixth wire 56 of the second row 122 into the sixth opening 33f to be coupled with the sixth receiving part 313b, the electrical coupling between the fifth and sixth wires 55, 56 are obtained. Furthermore, the fifth receiving part 313a includes one protrusion that may jut out from and be perpendicular to the extending part 313c for coupling with the fifth wire 55.

In some embodiments of the disclosure, the fourth connection sheet 314 has the seventh, the eighth and the ninth receiving parts 314a, 314b, 314d, and an extending part 314c that connects the seventh, the eighth and the ninth receiving parts 314a, 314b, 314d. The seventh, the eighth and the ninth openings 33g, 33h, 33i are formed on the outer surface 304 and extend through the first surface 301 and the second surface 302. Along the lengthwise direction of the electrical connection caps 3, the seventh opening 33g is positioned between the fourth and the sixth openings 33d, 33f, the sixth opening 33f is positioned between the seventh and eighth openings 33g, 33h, and the eighth opening 33h is positioned between the seventh and ninth openings 33g, 33i. The seventh, the eighth and the ninth receiving parts 314a, 314b, 314d are positioned in the seventh, eighth and ninth openings 33g-33i, respectively. By placing the seventh, the eighth and the ninth wires 57, 58, 59 located in the first row 121 into the seventh, the eighth and the ninth openings 33g-33i to be coupled with the seventh, the eighth and the ninth receiving parts 314a, 314b, 314d, the electrical couplings between the seventh, the eighth and the ninth wires 57-59 are attained.

In this embodiment, since the fourth and seventh openings 33d, 33g are positioned between the fifth and sixth openings 33e, 33f, the third connection sheet 313 may extend above the fourth and seventh receiving parts 312b, 314a in order to prevent the third connection sheet 313 from contacting the second and fourth connection sheets 312, 314. In other words, the third connection sheet 313 overlaps and is not in direct contact with the fourth and seventh receiving parts 312b, 314a. As shown in FIG. 3, the body of the housing 30 has a hump 36 swelling out of the first surface 301 to accommodate the third connection sheet 313.

The relative locations between the third and the fourth connection sheets 313, 314 may be adjusted according to actual requirements. For example, in one embodiment, the third connection sheet 313 is located above the fourth connection sheet 314. The fifth and the sixth openings 33e, 33f are located between the seventh and the eighth openings 33g, 33h such that the fifth and the sixth receiving parts 313a, 313b are located between the seventh and the eighth receiving parts 314a, 314b.

In one embodiment of the disclosure as shown in FIG. 2, the first electrical connection cap 3 further includes the first and second cables 321, 322. The first cable 321 has a first connecting section 321a, a first positioning section 321b and a first extending section 321c that are connected in series. The first connecting section 321a is positioned in the first orifice 34a that is formed on the inner surface 303 and that extends through the first surface 301 and the second surface 302. The first positioning section 321b is positioned onto the first surface 301 of the core body 11. The first extending section 321c extends towards a direction farther away from the stator 100 along the axis A1 in order to be connected to another component (not shown); for example, a rectifier. A tenth wire 60 of the windings 2 protrudes out of a slot to connect the first connecting section 321a of the first cable 321 in the first orifice 34a. Furthermore, in some embodiments, the materials of the first and second cables 321, 322 may be the same or similar to those of the wires 51-59.

As shown in FIG. 2, the housing 30 further includes a block 35 positioned in the first orifice 34a and has a through hole therein. The first connection section 321a abuts and is coupled with the tenth wire 60 received in the through hole, the size of which may be configured to receive the tenth wire 60 and the first connecting section 321a therein. The block 35 may be made of a conducting material, for example, metal. The block 35 may be placed into a mold before the housing 30 is formed in the mold, in order that the block 35 can be embedded in the housing 30. In some embodiments, the tenth wire 60 and the first cable 321 may be bent or twisted together, or soldered together to enhance the electrical contact.

Similarly, the second cable 322 is coupled with an eleventh wire 61 in a through hole of a block 38 of the second orifice 34b. A part of the second cable 322 is also positioned on the first surface 301, and another part of the second cable 322 extends away from the stator 100. In this embodiment, the first positioning section 321b is stacked on the part of the second cable 322 leaning against a side of the hump 36 facing the axis A1. The electrical connection cap 3 further includes a cover 37 that extends out of the hump 36 and towards the axis A1 for covering and positioning the first positioning section 32 lb of the first cable 321. Accordingly, the wires 60, 61 only need to vertically extend out of a slot 12 of the stator 100 to be coupled with the cable 321, 322.

The configuration of the second electrical connection cap 4 is similar to that of the first electrical connection cap 3. In some embodiments of the disclosure as shown in FIGS. 2 and 5, the second electrical connection cap 4 includes a housing 40, the fifth, the sixth, the seventh and the eighth connection sheets 415-418, all of which are embedded within the housing 40. The fifth, the sixth and the eighth connection sheets 415, 416, 418 are arranged side by side and spaced apart from each other. The seventh connection sheet 417 is disposed across the sixth and the eighth connection sheets 416, 418 and separated by the sixth and the eighth connection sheets 416, 418 by a portion of the housing 40 such that the seventh connection sheet 417 is not in direct contact with the sixth and the eighth connection sheets 416, 418. The seventh connection sheet 417 is embedded in a hump 46 jutting out of a top surface 401 of the housing 40. Each of the fifth, the sixth, the seventh and the eighth connection sheets 415-418 has at least two receiving parts exposed from two openings of the housing 40 for coupling two wires, respectively. Hence, the two wires are coupled with each other via the respective connection sheets 415-418. Moreover, in some embodiments of the disclosure, the eighth connection sheet 418 has three receiving parts 418a, 418b, 418c that are separate from each other. Three wires 65 from different slots 12 are coupled with each other via the eighth connection sheet 418.

In addition, in some embodiments of the disclosure, the housing 40 includes a third orifice 44a that is formed on an inner surface 403 of the housing 40, and that extends through the top surface 401 and a bottom surface 402 of the housing 40. As shown in FIGS. 2 and 4, a twelfth wire 62 may protrude out of a slot 12 and vertically penetrate through the third orifice 44a to extend away from the stator 100 such that the twelfth wire 62 can be coupled with another component, for example, a rectifier. In some embodiments of the disclosure, the second electrical connection cap 4 may include a block 45 disposed in the third orifice 44a and immediately next to the twelfth wire 62, and a third cable 421 having a connection section 421a disposed in a through hole in the block 45, a positioning section 421b disposed on and extending over the top surface 401 of the housing 40, and an extending section 421c extending away from the stator 100 to be coupled with another component; for example, a rectifier. A thirteenth wire 63 may be directly coupled with the connection section 421a of the third cable 421 within the hole of the block 45, such that the thirteenth wire 63 is coupled with the rectifier via the third cable 421. Moreover, the housing 40 may further include a cover 47 extending from the hump 46 for the purpose of positioning and covering a portion of the positioning section 421b of the third cable 421. During assembly, the third cable 421 may be engaged with the housing 40 by inserting the connection section 421a into the block 45 and placing the portion of the positioning section 421b into the space defined by the cover 47 and the top surface 401.

In some embodiments of the disclosure, the second electrical connection cap 4 further has a notch 48 formed on the outer surface of the housing 40. A fourteenth wire 64 may penetrate through the notch 48 from a slot 12 and extend away from the stator 100 along the axis A1 in order to be coupled with another component; for example, a rectifier.

During the assembly, numerous wires 51-64 are installed into slots 12 of the stator 100 to form several stator windings 2. Outputs of the stator windings 2, i.e., ends of wires 51-64, may vertically protrude out of the slots 12. The cables 321, 322, 421 may be installed on the housing 30 by inserting an end of the cables 321, 322, 421 into the blocks 35, 38, 45 and bending the cables 321, 322, 421 to form the connection, positioning and extending sections 321a-c, 322a-c, 421a-c, respectively. The electrical connection caps 3, 4 may be placed onto the top of the stator windings 2 while each wire 51-64 may be directly vertically inserted into the respective openings 33a-33i or orifices 34a, 34b, 44a. Thus, the coupling between the stator windings 2 and the rectifier is attained.

As the space between a top shell (not shown) and the stator may be limited, the electrical connection caps 3, 4 are configured to be slim enough to be located within the space. Furthermore, the electrical connection caps 3, 4 may be arc-shaped corresponding to the shape of the stator core 1 in order to prevent the electrical connection caps 3, 4 from interference with the top shell, a bottom shell, and a rotor surrounded by the stator.

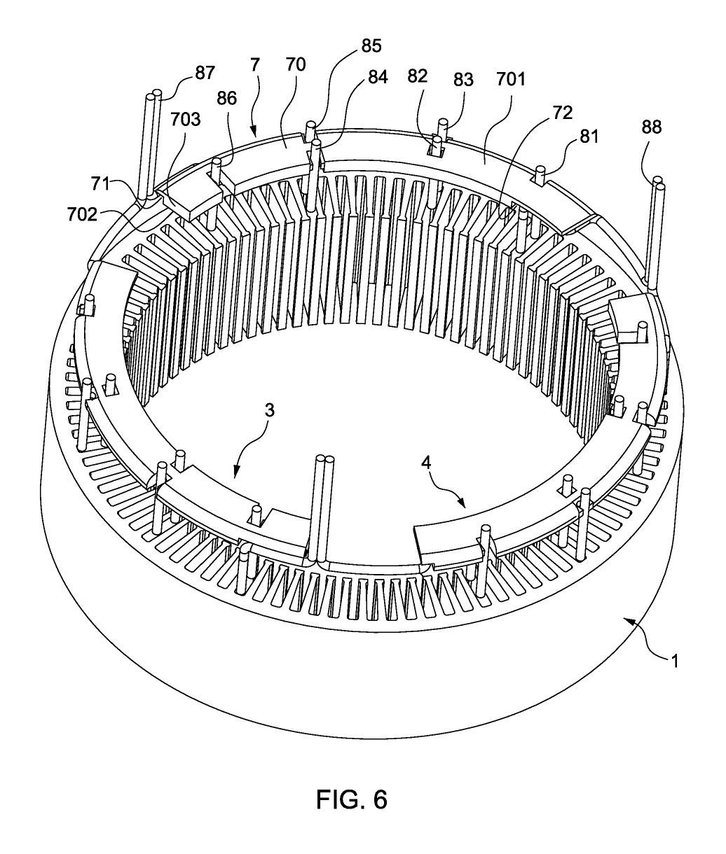

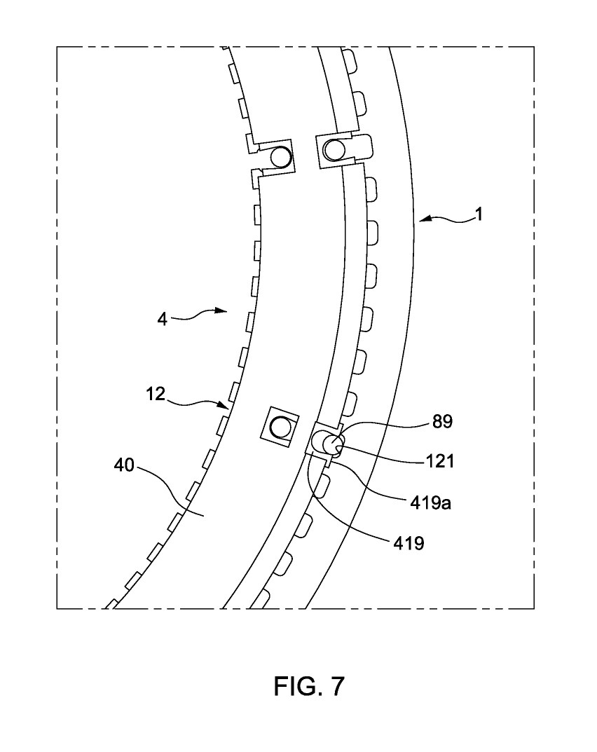

FIG. 6 is a perspective view of a stator 200 according to another embodiment of the disclosure, and FIG. 7 is a regionally enlarged top view of the stator 200 in FIG. 6. It should be noted that most wires are omitted in FIGS. 6-7 to clearly show the electrical connection caps of a stator. In this embodiment, the stator 200 includes three electrical connection caps 3, 4, 7 disposed above a stator core 1. Take the electrical connection cap 7 for example, the electrical connection cap 7 includes a housing 70 having a first surface 701, a second surface 702 and a side surface 703. The side surface 703 connects the first surface 701 and the second surface 702. Multiple openings penetrate through the first surface 701 and the second surface 702. Multiple wires 81-86 are disposed in the openings. In this embodiment, the wires 81, 82 are connected to each other via a first connection sheet (not shown) embedded inside the body 70; the wires 83, 84 are connected to each other via a second connection sheet (not shown) embedded inside the body 70; the wires 85, 86 are connected to each other via a third connection sheet (not shown) embedded inside the body 70. The first, second, third connection sheets (not shown) are separated from each other in order to avoid short circuit. In addition, the wires 81, 88 are located in the same groove, the wires 82, 83 are located in the same groove; the wires 84, 85 are located in the same groove; and the wires 86, 87 are located in the same groove.

In this embodiment, two recesses 71, 72 are formed on the second surface 702 and extend along the annular direction of the cap 7. Besides, the recesses 71, 72 are formed on two opposite ends of the electrical connection cap 7. The wires 87, 88 protrude out of the stator core 1, and a fraction of the wires 87, 88 are bent and located in the recess 71, 72. Another fraction of the wires 87, 88 extend along the recesses 87, 88 and protrude out of the electrical connection cap 7 such that the wires 87, 88 are capable of extending further away from the stator core 1. By forming the recesses 71, 72 on the second surface 702, the wires 87, 88 can be well arranged and positioned in the recesses 71, 72 between the body 70 and the stator core 1.

As shown in FIG. 7, a wire 89 is located on the bottom side 121 of a groove 12, and a first receiving part 419 of an electrical connection sheet of the electrical connection cap 4 may protrude further away from the outer periphery of the housing 40 of the electrical connection cap 4 in order to be properly coupled to the wire 89. However, as the first receiving part 419 is protruded out, it may be accidentally in contact with an outer shell (e.g., a side of a top or a bottom shell of the stator 100), thereby generating undesired short circuit. In this embodiment, to resolve this issue, the first receiving part 419 has a side surface 419a facing away from the housing 40, which is coated with an insulation. By disposing the insulation coating on the side surface 419a of the first receiving part 419, the undesired short circuit between the first receiving part 419 and the outer shell can be avoided.

In accordance with some embodiments of the disclosure, an electrical connection cap, located atop windings, has at least one connection sheet embedded therein, and two wires protruding out of slots may be coupled with each other through the connection sheet of the electrical connection cap. When the electrical connection cap(s) is disposed atop the windings, the configuration of the electrical connection cap(s) allows the two wires to be directly coupled with the corresponding connection sheet along the axis of the stator. Thus, it is unnecessary to bend or pull the wires for electrical connection with each other. In addition, a cable may be provided to couple with a wire in the electrical connection cap. In the event that the wire located on one side of the stator is coupled with the cable extending from the side towards another side of the stator, the wire can be coupled to another component located above the said other side, via the cable.

Specific components of an insertion system and related methods for insertion have been described. It should be, however, apparent to those skilled in the art that many more modifications besides those already described are possible without departing from the inventive concepts herein. The inventive subject matter, therefore, is not to be restricted except in the spirit of the present disclosure. Moreover, in interpreting the present disclosure, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced.

What is claimed is:

1. An electrical connection cap of a stator, the electrical connection cap comprising:
a housing having a first opening and a second opening; and
at least one connection sheet embedded within the housing and having a first receiving part positioned in the first opening, and a second receiving part positioned in the second opening.

2. The electrical connection cap of the stator of claim 1, wherein the housing is arc-shaped and surrounds an axis of the stator.

3. The electrical connection cap of the stator of claim 1, wherein the housing includes a body having a first surface and a second surface opposing the first surface, the first opening is configured to extend through the first surface to the second surface.

4. The electrical connection cap of the stator of claim 1, wherein the first opening is formed on an edge of the body.

5. The electrical connection cap of the stator of claim 3, wherein the at least one connection sheet includes a first connection sheet and a second connection sheet that is separated from the first connection sheet by a portion of the housing.

6. The electrical connection cap of the stator of claim 1, wherein the first connection sheet has the first receiving part and the second receiving part, the second connection sheet has a third receiving part and a fourth receiving part, the housing has a third opening and a fourth opening, the third receiving part is positioned in the third opening, the fourth receiving part is positioned in the fourth opening.

7. The electrical connection cap of the stator of claim 6, wherein the second opening is positioned between the first opening and the third opening, and the third opening is positioned between the second opening and the fourth opening.

8. The electrical connection cap of the stator of claim 6, wherein the third opening is positioned between the first opening and the second opening, and the second opening is positioned between the third opening and the fourth opening.

9. The electrical connection cap of the stator of claim 6, wherein the housing has a first side and a second side opposite to the first side, the first connection sheet includes a first extending part connecting the first receiving part with the second receiving part, and the second connection sheet includes a second extending part connecting the third receiving part with the fourth receiving part.

10. The electrical connection cap of claim 9, wherein the distance between the first side and the first extending part is shorter than the distance between the first side and the second extending part.

11. The electrical connection cap of claim 9, wherein the first opening is formed on the first side and the second opening is formed on the second side.

12. The electrical connection cap of the stator of claim 6, wherein the housing includes a body having a first surface and a second surface opposing the first surface, the first opening is formed through the first surface and the second surface, and the first connection sheet is positioned between the first surface and the second connection sheet.

13. The electrical connection cap of claim 6, wherein both the first opening and the second opening are formed on the first side.

14. The electrical connection cap of the stator of claim 1, wherein each of the at least one connection sheet includes a first extending part connecting the first receiving part with the second receiving part, and the first receiving part includes two protrusions jutting out from the first extending part, and are spaced apart from each other by a distance.

15. The electrical connection cap of the stator of claim 1, wherein the housing has an orifice; and the electrical connection cap further comprises:
a cable having a connecting section, a positioning section and an extending section that are connected in series, the connecting section being positioned in the orifice, the positioning section being positioned on top of the housing, and the extending section extending towards a direction farther away from the stator.

16. The electrical connection cap of the stator of claim 15, further comprising:
a block positioned in the orifice and having a through hole therein, the block being coupled to the connection section of the wire received in the through hole thereof.

17. The electrical connection cap of the stator of claim 15, wherein the housing has a cover leaning against, and covering a part of, the positioning section.

18. The electrical connection cap of the stator of claim 1, wherein the first receiving part has a side surface facing away from the housing, the side surface being coated with an insulation.

19. The electrical connection cap of the stator of claim 1, wherein the housing has a first surface, and a second surface opposing the first surface, wherein a recess is formed on the second surface and is provided at an end of the housing.

20. A stator, comprising:
a stator core having a plurality of teeth that are circumferentially spaced apart and radially extending, the plurality of teeth defining a plurality of slots each formed between two of the plurality of teeth adjacent to each other;
a stator winding, wound around the plurality of teeth and including a first wire, a second wire and a third wire, each of which extends out of the plurality of slots; and
an electrical connection cap positioned on an axial side of the stator winding, the electrical connection cap comprising:
a housing having a first opening, a second opening and an orifice; and
at least one connection sheet embedded within the housing and having a first receiving part positioned in and exposed from the first opening, and a second receiving part positioned in and exposed from the second opening, the first wire coupled to the first receiving part in the first opening, the second wire coupled to the second receiving part in the second opening; and
a cable having a connecting section, a positioning section and an extending section that are connected in series, the connecting section being coupled to the third wire in the orifice, the positioning section being positioned on top of the housing, and the extending section extending towards a direction farther away from the stator core.
